(19) United States
(12) Patent Application Publication
(10) Pub. No.: US 2017/0248444 A1
(43) Pub. Date: Aug. 31, 2017

(54) POSITION DETECTION DEVICE

(71) Applicant: DENSO CORPORATION, Kariya-city, Aichi-pref (JP)

(72) Inventors: Shinji HATANAKA, Kariya-city (JP); Motoki TACHIIRI, Nishio-city (JP)

(73) Assignee: DENSO CORPORATION, Kariya-city, Aichi-pref (JP)

(21) Appl. No.: 15/505,494

(22) PCT Filed: Aug. 26, 2015
(86) PCT No.: PCT/JP2015/004281

§ 371 Date: Feb. 21, 2017

(30) Foreign Application Priority Data
Aug. 29, 2014 (JP) 2014-175904

(51) Int. Cl. G01D 5/12

(52) U.S. Cl. CPC G01D 5/12; G06F 3/046

(57) ABSTRACT

An operation device includes a movable part movable in X- and Y-axis directions, a magnet movable integrally with the movable part, and a magnetic field sensor detecting a magnetic field of the magnet. The magnet includes a magnetic field detection surface including X-axis-direction sides, Y-axis-direction sides, and connection sides. The X-axis-direction sides are parallel with each other along the X-axis direction. The Y-axis-direction sides are parallel with each other along the Y-axis direction. The connection sides each shaped as an arc or a line connect respective end portions of the X-axis-direction sides and respective end portions of the Y-axis-direction sides. The magnetic field detection surface is line-symmetric with respect to respective lines parallel with the X- and Y-axis directions. The magnetic field sensor is opposed to the magnetic field detection surface and detects respective components of a magnetic flux density of the magnet in the X- and Y-directions.

### CROSS REFERENCE TO RELATED APPLICATION

This application is based on Japanese Patent Application No. 2014-175904 filed on Aug. 29, 2014, the disclosure of which is incorporated herein by reference.

### TECHNICAL FIELD

The present disclosure relates to a position detection device which detects the position of a movable part capable of moving in an X-axis direction and a Y-axis direction which are orthogonal to each other.

### BACKGROUND ART

Conventionally, a device has been known which includes a movable part capable of moving in an X-axis direction and a Y-axis direction which are orthogonal to each other, a magnet attached to the movable part, and a magnetic sensor which detects a magnetic field generated by the magnet. The device is configured to be able to detect the position of the movable part (see, e.g., Patent Literature 1).

### PRIOR ART LITERATURE

### Patent Literature

Patent Literature 1: JP2013-103668A

### SUMMARY OF INVENTION

However, since the distribution of the magnetic field generated by the magnet attached to the movable part is complicated, sophisticated arithmetic operations are required to calculate the positions in the X-direction and in the Y-direction on the basis of the result of the detection by the magnetic sensor.

An object of the present disclosure is to provide a position detection device capable of detecting a position on the basis of the result of the detection by a magnetic sensor and using a simple and easy arithmetic operation.

According to an aspect of the present disclosure, a position detection device includes a movable part which is movable in an X-axis direction and a Y-axis direction which are orthogonal to each other, a magnet which is movable integrally with the movable part, and a magnetic field detector which detects a magnetic field of the magnet. The magnet includes a magnetic field detection surface which is a surface having a shape including two X-axis-direction sides, two Y-axis-direction sides, and four connection sides. The two X-axis-direction sides are arranged to be parallel with each other along the X-axis direction. The two Y-axis-direction sides are arranged to be parallel with each other along the Y-axis direction. The four connection sides each shaped as an arc or a line connect respective end portions of the X-axis-direction sides and respective end portions of the Y-axis-direction sides. The magnetic field detection surface is formed to be line-symmetric with respect to a line parallel with the X-axis direction and line-symmetric with respect to a line parallel with the Y-axis direction. The magnetic field detector is disposed to oppose the magnetic field detection surface and detect a component of the magnetic field of the magnet in the X-axis direction and a component of the magnetic field of the magnet in the Y-axis direction.

In the position detection device thus configured, the magnetic field detection surface is formed to include the two X-axis-direction sides, the two Y-axis-direction sides, and the fourth connection sides each shaped as the arc or line. Accordingly, when the position in the Y-axis direction is changed in the state where the position in the X-axis direction is fixed in the position detection device in the present disclosure, a change in the X-axis-direction component of the magnetic field resulting from the position change in the Y-axis direction can be reduced.

As a result, it is possible to calculate the position of the magnet in the X-axis direction on the basis of the X-axis-direction component of the magnetic field detected by the magnetic field detector without using the Y-axis-direction component of the magnetic field detected by the magnetic field detector.

Likewise, when the position in the X-axis direction is changed in the state where the position in the Y-axis direction is fixed, a change in the Y-axis-direction component of the magnetic field resulting from the position change in the X-axis direction can be reduced.

As a result, it is possible to calculate the position of the magnet in the Y-axis direction on the basis of the Y-axis-direction component of the magnetic field detected by the magnetic field detector without using the Y-axis-direction component of the magnetic field detected by the magnetic field detector.

Thus, it is possible to calculate the position of the movable part in the X-axis direction using only the X-axis-direction component of the magnetic field and also calculate the position of the movable part in the Y-axis direction using only the Y-axis-direction component of the magnetic field. This allows the position of the movable part to be detected using a simple and easy arithmetic operation.

### BRIEF DESCRIPTION OF DRAWINGS

The above and other objects, features and advantages of the present disclosure will become more apparent from the following detailed description made with reference to the accompanying drawings, in which:

FIG. 1A is a block diagram showing a schematic configuration of a remote operation system;

FIG. 1B is a schematic diagram illustrating the movable range of a movable part of an operation device in two-dimensional directions;

FIG. 2 is a perspective view showing a configuration of the operation device;

FIG. 3A is a plan view of a magnet in a first embodiment;

FIG. 3B is a side view of a position detector in the first embodiment;

FIG. 4 is a view showing the distribution of the X-axis-direction component of a magnetic flux density in the first embodiment;

FIG. 5 is a graph showing changes in the X-axis-direction component of the magnetic flux density in the first embodiment;

FIG. 6 is a view showing the distribution of the X-axis-direction component of the magnetic flux density in a magnet having a square shape;

FIG. 7 is a graph showing changes in the X-axis-direction component of the magnetic flux density in the magnet having the square shape;

FIG. 8 is a view showing the distribution of the X-axis-direction component of the magnetic flux density in a magnet having a circular shape;

FIG. 9 is a graph showing changes in the X-axis-direction component of the magnetic flux density in the magnet having the circular shape;

FIG. 10 is a flow chart showing a coordinate calculation process;

FIG. 11 is a graph showing the relationship between the shape of a magnet and fluctuations in the X-axis-direction component of the magnetic flux density in the first embodiment;

FIG. 12A is a plan view of a magnet in a second embodiment;

FIG. 12B is a side view of a position detector in the second embodiment;

FIG. 13 is a view showing the distribution of the X-axis-direction component of a magnetic flux density in the second embodiment;

FIG. 14 is a graph showing changes in the X-axis-direction component of the magnetic flux density in the second embodiment;

FIG. 15 is a view showing the distribution of the X-axis-direction component of the magnetic flux density in a magnet in which a blank distance C is 0.5×L;

FIG. 16 is a graph showing changes in the X-axis-direction component of the magnetic flux density in the magnet in which the blank distance C is 0.5×L; and

FIG. 17 is a graph showing the relationship between the shape of a magnet and fluctuations in the X-axis-direction component of the magnetic flux density in the second embodiment.

### DESCRIPTION OF EMBODIMENTS

### First Embodiment

The following will describe a first embodiment of the present disclosure in association with the drawings.

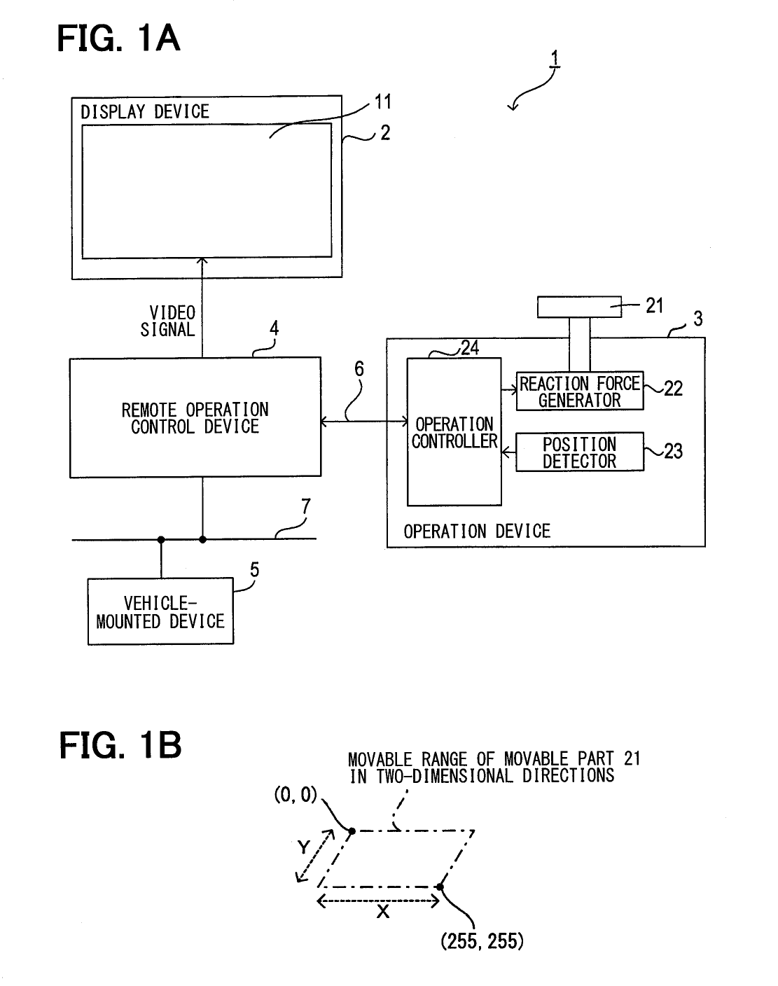

A remote operation system 1 in the present embodiment is mounted in a vehicle and includes a display device 2, an operation device 3, a remote operation control device 4, and a vehicle-mounted device 5 (such as, e.g., a navigation device, an audio device, or an air conditioning device), as shown in FIG. 1A.

The display device 2 is a color display device having a display screen 11 such as a liquid crystal display and displays various images on the display screen 11 in accordance with a video signal input thereto from the remote operation control device 4.

The display device 2 is disposed at a middle position between a driver seat and a passenger seat on a dashboard (not shown) located in front of a driver in a vehicle interior. This reduces the eye movement of the driver when the driver looks at the display screen 11 of the display device 2.

The operation device 3 is a pointing device for inputting the direction of movement of a cursor and a determined instruction on the display screen 11. The operation device 3 is disposed on the upper surface of a center console (not shown) directly beside the driver seat. The driver can easily operate the operation device 3 without reaching out his hand too far or changing his posture.

The operation device 3 includes a movable part 21, a reaction force generator 22, a position detector 23, and an operation controller 24.

The movable part 21 is configured to be movable in an X-axis direction (widthwise direction of a vehicle) and in a Y-axis direction (front-to-rear direction of the vehicle) when operated by the driver.

As shown in FIG. 1B, the respective coordinates of the movable part 21 in the X-axis direction and the Y-axis direction have integral values of 0 to 255 in each of an X-direction and a Y-direction.

The reaction force generator 22 applies a reaction force to the movable part 21 on the basis of the coordinate of the movable part 21 in the X-axis direction (hereinafter referred to as the X-axis coordinate) and the coordinate of the movable part 21 in the Y-axis direction (hereinafter referred to as the Y-axis coordinate).

The position detector 23 detects the respective positions of a magnet 51 described later in the X-axis direction and the Y-axis direction and outputs a movable-part position signal showing the positions.

The operation controller 24 calculates the X- and Y-axis coordinates of the movable part 21 (hereinafter referred to as the movable part coordinates) on the basis of the movable-part position signal from the position detector 23 and outputs the calculated movable part coordinates to the remote operation control device 4. When the movable part 21 is out of a neutral position, the operation controller 24 causes the reaction force generator 22 to generate a reaction force for returning the movable part 21 to the neutral position on the basis of the calculated movable part coordinates.

The remote operation control device 4 is configured around a known microcomputer including a CPU, a ROM, a RAM, an I/O, a bus line connecting these components, and the like to perform various processes for allowing the driver to perform a remote operation.

The remote operation control device 4 is also connected to the operation device 3 such that the remote operation control device 4 and the operation device 3 can communicate with each other via a dedicated communication line 6. The remote operation control device 4 is also connected to the vehicle-mounted device 5 such that the remote operation control device 4 and the in-vehicle device 5 can communicate with each other via an in-vehicle LAN (Local Area Network) 7.

The remote operation control device 4 causes the display device 2 to display an operation image for operating the vehicle-mounted device 5. The remote operation control device 4 causes the driver to select among various icons arranged over the operation screen via the operation device 3 and receives an instruction to perform the function assigned to the selected icon. In this manner, the remote operation control device 4 causes the vehicle-mounted device 5 to perform the function assigned to the icon selected according to the instruction.

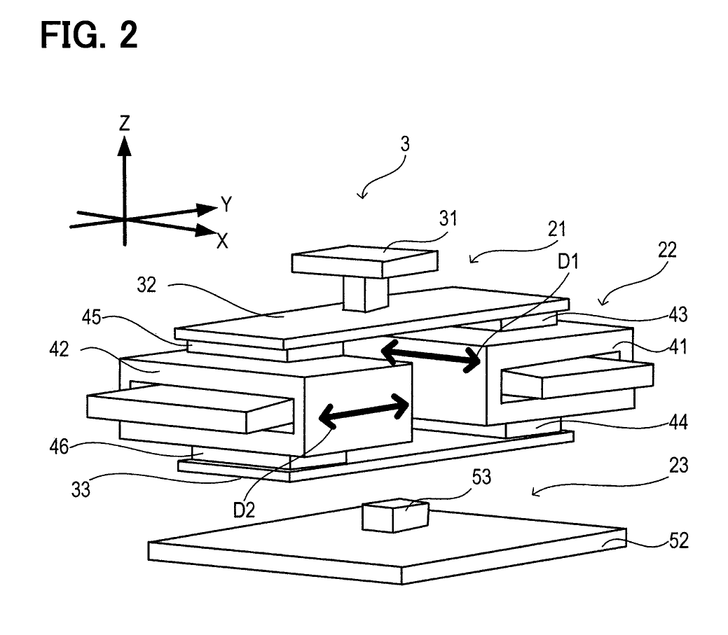

The movable part 21 of the operation device 3 includes a grip 31, an upper yoke 32, and a lower yoke 33, as shown in FIG. 2.

The grip 31 is a portion held by the driver.

The upper yoke 32 is formed of a magnetic material such as iron to have a rectangular plate shape. The upper yoke 32 is connected to the grip 31 such that the grip 31 is located over the upper yoke 32.

The lower yoke 33 is formed of a magnetic material such as iron to have a rectangular plate shape. The lower yoke 33 is disposed opposite to the grip 31 relative to the upper yoke 32 interposed therebetween so as to be opposed to the upper yoke 32. The lower yoke 33 is connected to the upper yoke 32 to be movable integrally with the upper yoke 32.

The reaction force generator 22 of the operation device 3 includes electromagnets 41 and 42 and magnets 43, 44, 45, and 46.

Each of the electromagnets 41 and 42 is comprised of a core formed of a magnetic material and a coil wound around the core. The electromagnets 41 and 42 are disposed between the upper and lower yokes 32 and 33 opposed to each other. The electromagnet 41 is disposed such that an excitation direction D1 thereof is parallel with the X-axis direction. On the other hand, the electromagnet 42 is disposed such that an excitation direction D2 thereof is parallel with the Y-axis direction.

The magnet 43 is disposed between the upper yoke 32 and the electromagnet 41 to be connected to the upper yoke 32. The magnet 44 is disposed between the lower yoke 33 and the electromagnet 41 to be connected to the lower yoke 33.

The magnet 45 is disposed between the upper yoke 32 and the electromagnet 42 to be connected to the upper yoke 32. The magnet 46 is disposed between the lower yoke 33 and the electromagnet 42 to be connected to the lower yoke 33.

In the reaction generator 22 thus configured, the operation controller 24 supplies power to the coil of the electromagnet 41 to thus generate forces in accordance with the orientation and size of a magnetic field in the electromagnet 41 between the electromagnet 41 and the magnets 43 and 44. This allows a reaction force along the Y-axis direction to be applied to the movable part 21.

Likewise, the operation controller 24 supplies power to the coil of the electromagnet 42 to thus generate forces in accordance with the orientation and size of a magnetic field in the electromagnet 42 between the electromagnet 42 and the magnets 45 and 46. This allows a reaction force along the Y-axis direction to be applied to the movable part 21.

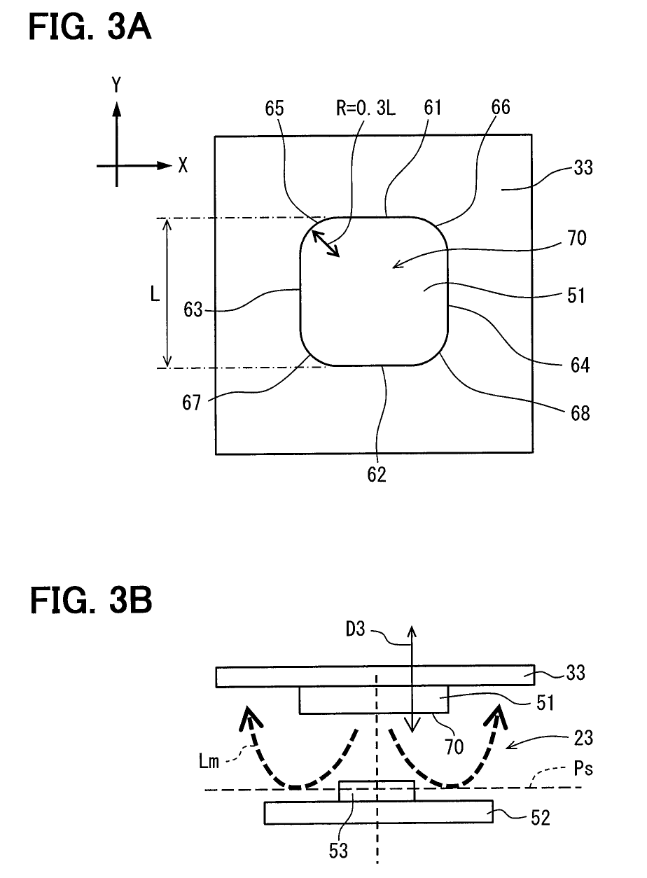

The position detector 23 includes the magnet 51 (see FIGS. 3A and 3B), a sensor supporting plate 52, and a magnetic sensor 53.

As shown in FIG. 3A, the magnet 51 is formed in a generally rectangular shape having corner portions each shaped as an arc. Specifically, the magnet 51 is formed to have a magnetic detection surface 70 including X-axis-direction sides 61 and 62 extending along the X-axis direction, Y-axis-direction sides 63 and 64 extending along the Y-axis direction, and connection sides 65, 66, 67, and 68.

The X-axis-direction sides 61 and 62 are arranged to be parallel with each other along the Y-axis direction. The Y-axis-direction sides 63 and 64 are arranged to be parallel with each other along the Y-axis direction.

The connection side 65 shaped as an arc connects the end portion of the X-axis-direction side 61 and the end portion of the Y-axis-direction side 63. The connection side 66 shaped as an arc connects the end portion of the X-axis-direction side 61 and the end portion of the Y-axis-direction side 64. The connection side 67 shaped as an arc connects the end portion of the X-axis-direction side 62 and the end portion of the Y-axis-direction side 63. The connection side 68 shaped as an arc connects the end portion of the X-axis-direction side 62 and the end portion of the Y-axis-direction side 64.

In the present embodiment, the magnet 51 is formed such that the distance between any two sides opposite to each other is L and the radius of the arc shape of each of the corner portions is 0.3×L.

The magnet 51 is provided such that an excitation direction D3 thereof is orthogonal to the surface formed in a generally rectangular shape (see FIG. 3B for a line of magnetic force Lm).

The surface of the magnet 51 which is opposite to the electromagnets 41 and 42 relative to the lower yoke 33 interposed therebetween is attached to the lower yoke 33 such that the excitation direction D3 of the magnet 51 is orthogonal to each of the X-axis direction and the Y-axis direction.

The sensor supporting plate 52 is formed in a plate-like shape and disposed opposite to the electromagnets 41 and 42 relative to the lower yoke 33 interposed therebetween so as to face the lower yoke 33.

The magnetic sensor 53 is attached onto the surface of the sensor supporting plate 42 so as to be opposed to the magnet 51. The magnetic sensor 53 detects the X- and Y-axis-direction components of a magnetic flux density and outputs a signal showing the X- and Y-axis-direction components as the movable part position signal described above. In the present embodiment, the magnetic sensor 53 is a hole IC and formed in a square shape having sides of 0.5×L.

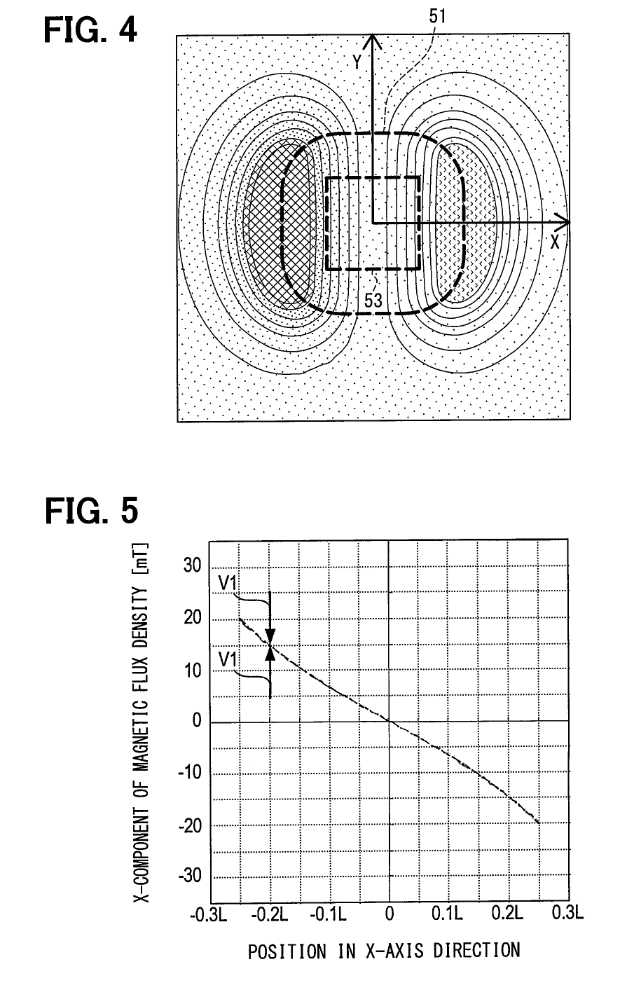

FIG. 4 shows the result of simulating the distribution of the X-axis-direction component in the density of a magnetic flux generated in the magnet 51 in the position detector 23 thus configured. As shown in FIG. 3B, the distribution of the magnetic flux density shows the magnetic flux density over a plane Ps including the sensitivity position of the magnetic sensor 53.

As shown in FIG. 4, the contour lines of the X-axis-direction component of the magnetic flux density are parallel with the Y-axis in the region corresponding to the center portion of the magnet 51. That is, when the position in the Y-axis direction is changed in the state where the position in the X-axis direction is fixed, changes in the X-axis-direction component of the magnetic flux density resulting from the position changes in the Y-axis direction are small. Accordingly, the X-axis-direction component of the magnetic flux is generally constant.

FIG. 5 is a graph showing changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density shown in FIG. 4.

As shown in FIG. 5, the curve showing the changes in the X-axis-direction component of the magnetic flux density resulting from the position changes in the X-axis direction barely changes with the position changes in the Y-axis direction from −0.25×L to +0.25×L (see the arrow V1).

Note that the magnet 51 is formed to be line-symmetrical with respect to a line along the Y-axis direction and also formed to be line-symmetrical with respect to the X-axis direction. Consequently, the contour lines of the Y-axis-direction component of the magnetic flux density are parallel with the X-axis in the region corresponding to the center portion of the magnet 51. That is, when the position in the X-axis direction is changed in the state where the position in the Y-axis direction is fixed, changes in the Y-axis-direction component of the magnetic flux density resulting from the position changes in the X-axis direction are small. Accordingly, the Y-axis-direction component of the magnetic flux density is generally constant. Also, the curve showing the changes in the Y-axis-direction component of the magnetic flux density resulting from the position changes in the Y-axis direction barely changes with the position changes in the X-axis direction from −0.25×L to +0.25×L.

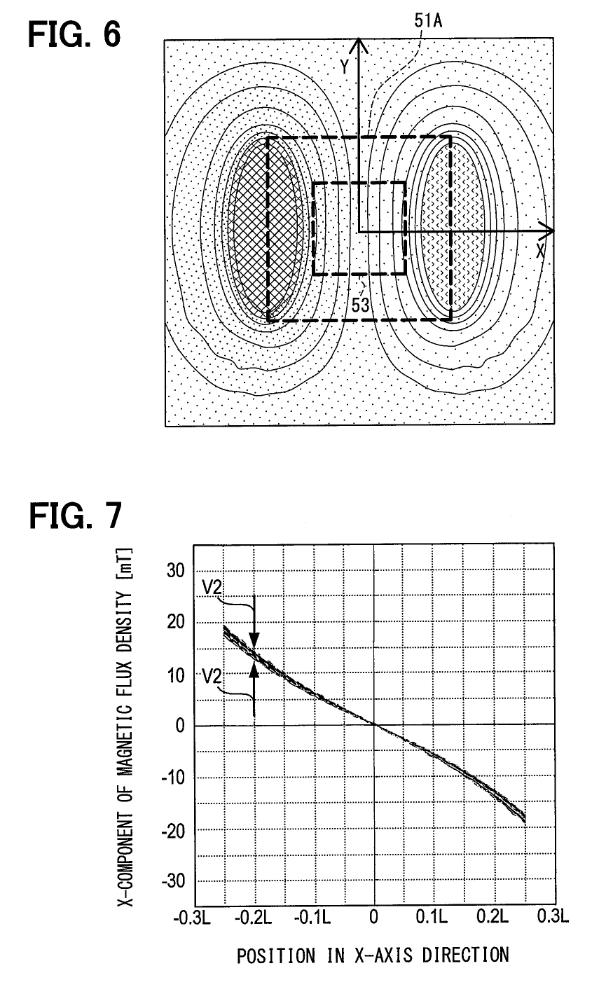

FIG. 6 shows the result of simulating the distribution of the X-axis-direction component of the magnetic flux density when a magnet 51A formed in a square shape having sides of L is used instead of the magnet 51.

As shown in FIG. 6, each of the contour lines of the X-axis-direction component of the magnetic flux density has an ellipsoidal shape having a long axis parallel with the Y-axis direction. That is, when the position in the Y-axis direction is changed in the state where the position in the X-axis direction is fixed, the X-axis-direction component of the magnetic flux density changes with the position changes in the Y-axis direction.

FIG. 7 is a graph showing changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density shown in FIG. 6.

As shown in FIG. 7, the curve showing the changes in the X-axis-direction component of the magnetic flux density resulting from the position changes in the X-axis direction shows large fluctuations with the position changes in the Y-axis direction from −0.25×L to +0.25×L (see the arrow V2).

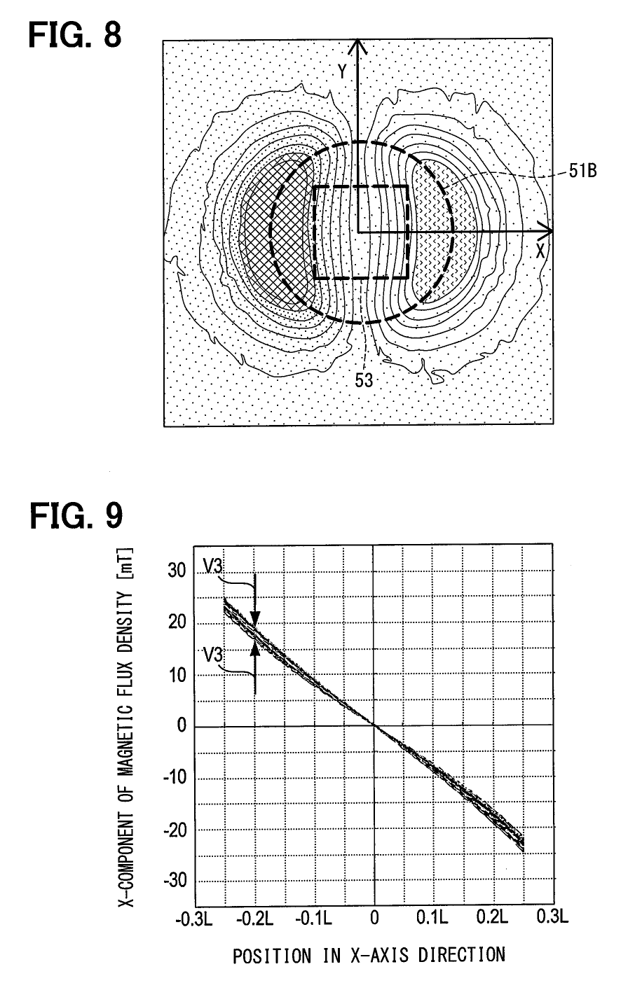

FIG. 8 shows the result of simulating the distribution of the X-axis-direction component of the magnetic flux density when a magnet 51B formed in a circular shape having a diameter of L is used instead of the magnet 51.

As shown in FIG. 8, the contour lines of the X-axis-direction component of the magnetic flux density are recessed in the region corresponding to the center portion of the magnet. That is, the X-axis-direction component of the magnetic flux density changes with position changes in the Y-axis direction when the position in the Y-axis direction is changed in the state where the position in the X-axis direction is fixed.

FIG. 9 is a graph showing changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density shown in FIG. 8.

As shown in FIG. 9, the curve showing the changes in the X-axis-direction component of the magnetic flux density resulting from the position changes in the X-axis direction shows large fluctuations with the position changes in the Y-axis direction from −0.25×L to +0.25×L (see the arrow V3).

The operation controller 24 performs a coordinate calculation process which calculates the coordinates of the movable part. The coordinate calculation process is repeatedly performed during the operation of the operation controller 24.

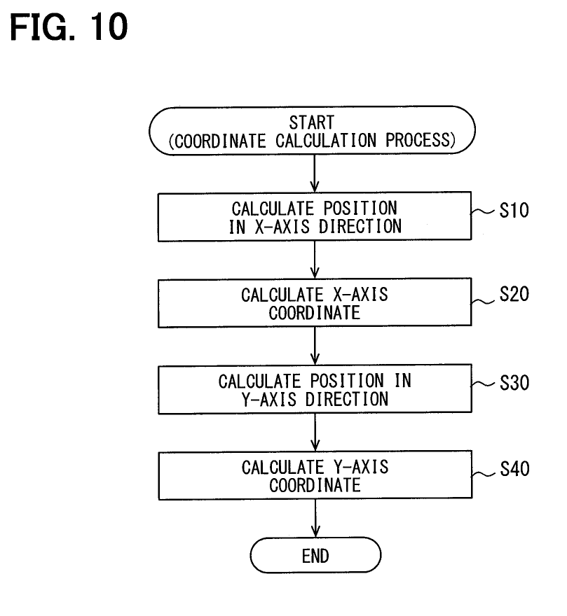

When the coordinate calculation process is performed, first, as shown in FIG. 10, the operation controller 24 calculates the position of the magnet 51 in the X-axis direction on the basis of the X-axis-direction component of the magnetic flux density shown by the movable-part position signal input from the position detector 23 in S10. Specifically, an X-axis-direction position calculation map showing the correspondence relationship between the position in the X-axis direction and the X-axis-direction component of the magnetic flux density is stored in advance in the operation controller 24. The operation controller 24 refers to the X-axis-direction position calculation map to calculate the position in the X-axis direction.

Then, in S20, the operation controller 24 calculates the X-axis coordinate of the movable part 21 on the basis of the position in the X-axis direction calculated in S10. Specifically, an X-axis-coordinate calculation map showing the correspondence relationship between the position in the X-axis direction and the X-axis coordinate is stored in advance in the operation controller 24. The operation controller 24 refers to the X-axis-coordinate calculation map to calculate the X-axis coordinate.

Next, in S30, the operation controller 24 calculates the position of the magnet 51 in the Y-axis direction on the basis of the Y-axis-direction component of the magnetic flux density shown by the movable-part position signal input from the position detector 23. Specifically, a Y-axis-direction position calculation map showing the correspondence relationship between the position in the Y-axis direction and the Y-axis-direction component of the magnetic flux density is stored in advance in the operation controller 24. The operation controller 24 refers to the Y-axis-direction position calculation map to calculate the position in the Y-axis direction.

Then, in S40, the operation controller 24 calculates the Y-axis coordinate of the movable part 21 on the basis of the position in the Y-axis direction calculated in S30. Specifically, a Y-axis-coordinate calculation map showing the correspondence relationship between the position in the Y-axis direction and the Y-axis coordinate is stored in advance in the operation controller 24. The operation controller 24 refers to the Y-axis-coordinate calculation map to calculate the Y-axis coordinate.

Then, when the process in S40 is ended, the coordinate calculation process is temporarily ended.

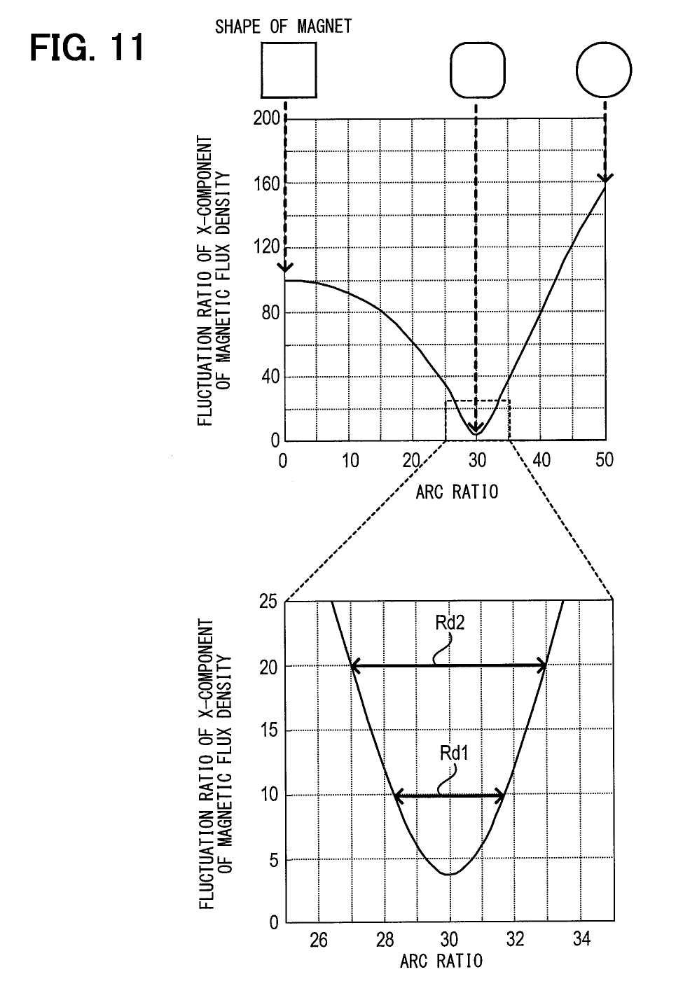

FIG. 11 is a graph showing the relationship between the shape of the magnet 51 and fluctuations in the X-axis-direction component of the magnetic flux density.

The abscissa axis of the graph shown in FIG. 11 represents the ratio (arc ratio) between the radius R of each of the corner portions shaped as the arc and the distance (L in the present embodiment) between any two sides opposite to each other. For example, in the case of using a magnet formed in a square shape (e.g., see FIG. 6 for the magnet 51A), there is no corner portion shaped as an arc so that the radius R is 0 and the arc ratio is 0. On the other hand, in the case of using a magnet formed in a circular shape (e.g., see FIG. 8 for the magnet 51B), the radius R is 0.5×L and the arc ratio is 50.

The ordinate axis of the graph shown in FIG. 11 represents the fluctuation ratio of the X-axis-direction component of the magnetic flux density, which is calculated by the method shown below.

First, from among a plurality of the magnets 51 having different arc ratios, the one 51 is selected according to the arc ratio. Then, for the magnet 51 selected according to the arc ratio, curves (hereinafter referred to as the magnetic flux change curves) showing the changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density are produced.

Then, for each of all the magnetic flux change curves produced, a standard variation at each of the positions in the X-axis direction is calculated. For example, the arrow V2 in FIG. 7 corresponds to the standard variation when the position in the X-axis direction is −0.2×L.

Then, among all the standard deviations calculated, the one having a largest value is assumed to be the degree of fluctuation of the magnet 51 selected according to the arc ratio.

Subsequently, the degree of fluctuation of the magnet 51 selected according to the arc ratio is divided by the degree of fluctuation when the magnet 51 has a square shape (i.e., when the arc ratio is 0). The value obtained by multiplying the resulting quotient by 100 is assumed to be the fluctuation ratio of the arc ratio of the selected magnet 51.

By performing the procedure of thus calculating the fluctuation ratio for each of the plurality of magnets 51 having the different arc ratios, the graph shown in FIG. 11 can be produced.

As shown in FIG. 11, as the arc ratio increases from 0, the fluctuation ratio decreases. When the arc ratio is 30, the fluctuation ratio is minimum. As the arc ratio further increases from 30, the fluctuation ratio increases.

By setting the arc ratio to 28 to 32, the fluctuation ratio can be reduced to a value of about not more than 10 (see the arrow Rd1). Also, by setting the arc ratio to 27 to 33, the fluctuation ratio can be reduced to a value of about not more than 20 (see the arrow Rd2).

The operation device 3 thus configured includes the movable part 21 which is movable in the X-direction and the Y-axis direction which are orthogonal to each other, the magnet 51 which is movable integrally with the movable part 21, and the magnetic sensor 53 which detects the magnetic field of the magnet 51.

The magnet 51 includes the magnetic field detection surface 70 having a shape including the two X-axis-direction sides 61 and 62, the two Y-axis-direction sides 63 and 64, and the four connection sides 65, 66, 67, and 68.

The two X-axis-direction sides 61 and 62 are arranged to be parallel with each other along the X-axis direction. The two Y-axis-direction sides 63 and 64 are arranged to be parallel with each other along the Y-axis direction. The four connection sides 65, 66, 67, and 68 each shaped as an arc connect the respective end portions of the X-axis-direction sides 61 and 62 and the respective end portions of the Y-axis-direction sides 63 and 64.

The magnetic field detection surface 70 is formed to be line-symmetric with respect to a line parallel with the X-axis direction and line-symmetric with respect to a line parallel with the Y-axis.

The magnetic sensor 53 is disposed to face the magnetic field detection surface 70 and detect the X-axis-direction component of the magnetic flux density of the magnet 51 and the Y-axis-direction component of the magnetic flux density of the magnet 51.

In the operation device 3 thus configured, the magnetic field detection surface 70 is formed to include the two X-axis-direction sides 61 and 62, the two Y-axis-direction sides 63 and 64, and the four connection sides 65, 66, 67, and 68 each shaped as an arc. As a result, in the operation device 3, when the position in the Y-axis direction is changed in the state where the position in the X-direction is fixed, changes in the X-axis-direction component of the magnetic flux density resulting from the position changes in the Y-axis direction can be reduced.

This allows the operation device 3 to calculate the position of the magnet in the X-axis direction on the basis of the X-axis-direction component of the magnetic flux density detected by the magnetic sensor 53 without using the Y-axis-direction component of the magnetic flux density detected by the magnetic sensor 53.

Likewise, in the operation device 3, when the position in the X-axis direction is changed in the state where the position in the Y-axis direction is fixed, changes in the Y-axis-direction component of the magnetic flux density resulting from the position changes in the X-axis direction can be reduced.

This allows the operation device 3 to calculate the position of the magnet 51 in the Y-axis direction on the basis of the Y-axis-direction component of the magnetic flux density detected by the magnetic field sensor 53 without using the X-axis-direction component of the magnetic flux density detected by the magnetic sensor 53.

Then, the operation device 3 calculates the position of the magnet 51 in the X-axis direction on the basis of the X-axis-direction component of the magnetic flux density detected by the magnetic sensor 53 without using the Y-axis-direction component of the magnetic flux density detected by the magnetic sensor 53 (S10). The operation device 3 also calculates the position of the magnet 51 in the Y-axis direction on the basis of the Y-axis-direction component of the magnetic flux density detected by the magnetic sensor 53 without using the X-axis-direction component of the magnetic flux density detected by the magnetic sensor 53 (S30).

Thus, with the operation device 3, it is possible to calculate the position of the movable part 21 in the X-axis direction using only the X-axis-direction component of the magnetic flux density and also calculate the position of the movable part 21 in the Y-axis direction using only the Y-axis-direction component of the magnetic flux density. This allows the position of the movable part 21 to be detected using simple and easy arithmetic operations.

In the embodiment described heretofore, the operation device 3 corresponds to a position detection device, the magnet 51 corresponds to a magnet, and the magnetic sensor 53 corresponds to a magnetic field detector. Also, the process in S10 is implemented by an X-axis-position calculator and the process in S30 is implemented by a Y-axis-position calculator.

### Second Embodiment

The following will describe a second embodiment in the present disclosure in association with the drawings. Note that, in the second embodiment, a portion different from that in the first embodiment is described.

The remote operation system 1 in the second embodiment is different from that in the first embodiment in that the magnet 51 has been changed.

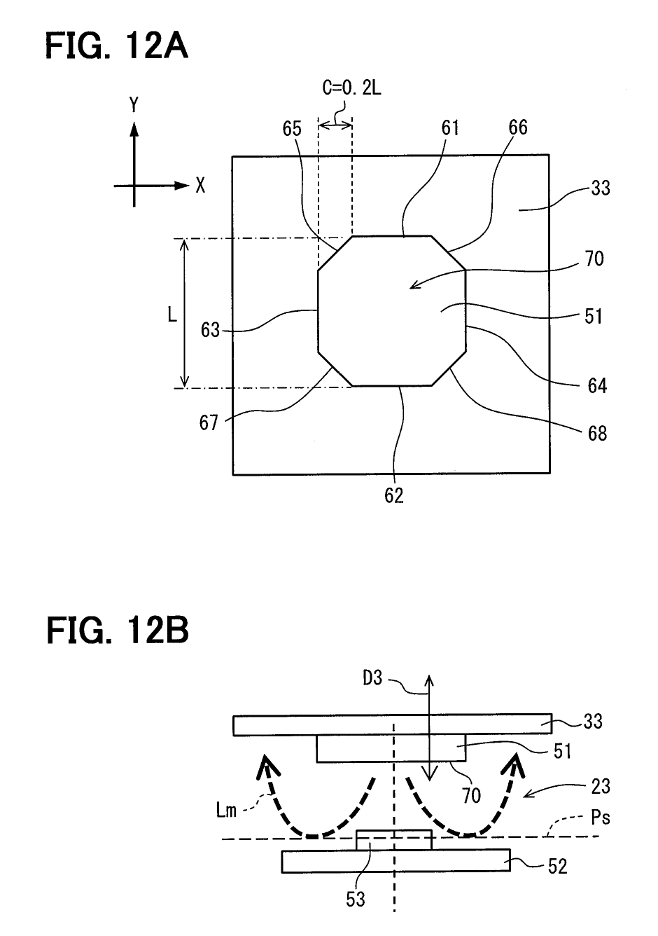

As shown in FIG. 12A, the magnet 51 in the second embodiment is formed in a generally rectangular shape in which the respective end portions of the X-axis-direction sides 61 and 62 and the respective end portions of the Y-axis-direction sides 63 and 64 are connected by lines.

Specifically, the magnet 51 is formed to have the magnetic field detection surface 70 including the X-axis-direction sides 61 and 62, the Y-axis-direction sides 63 and 64, and the connection sides 65, 66, 67, and 68.

The connection side 65 shaped as a line connects the end portion of the X-axis-direction side 61 and the end portion of the Y-axis-direction side 63. The connection side 66 shaped as a line connects the end portion of the X-axis-direction side 61 and the end portion of the Y-axis-direction side 64. The connection side 67 shaped as a line connects the end portion of the X-axis-direction side 62 and the end portion of the Y-axis-direction side 63. The connection side 68 shaped as a line connects the end portion of the X-axis-direction side 62 and the end portion of the Y-axis-direction side 64.

In the present embodiment, in the magnet 51, the distance between the two sides opposite to each other along the X-axis direction or the Y-axis direction is L. Also, in the magnet 51, a distance C (hereinafter referred to as the blank distance C) between the point of intersection (i.e., the corner of a square) of the extension line of the X-axis-direction side 61 or 62 and the extension line of the Y-axis-direction side 63 or 64 and the end portion of the X-axis-direction side 61 or 62 or the Y-axis-direction side 63 or 64 is 0.2×L.

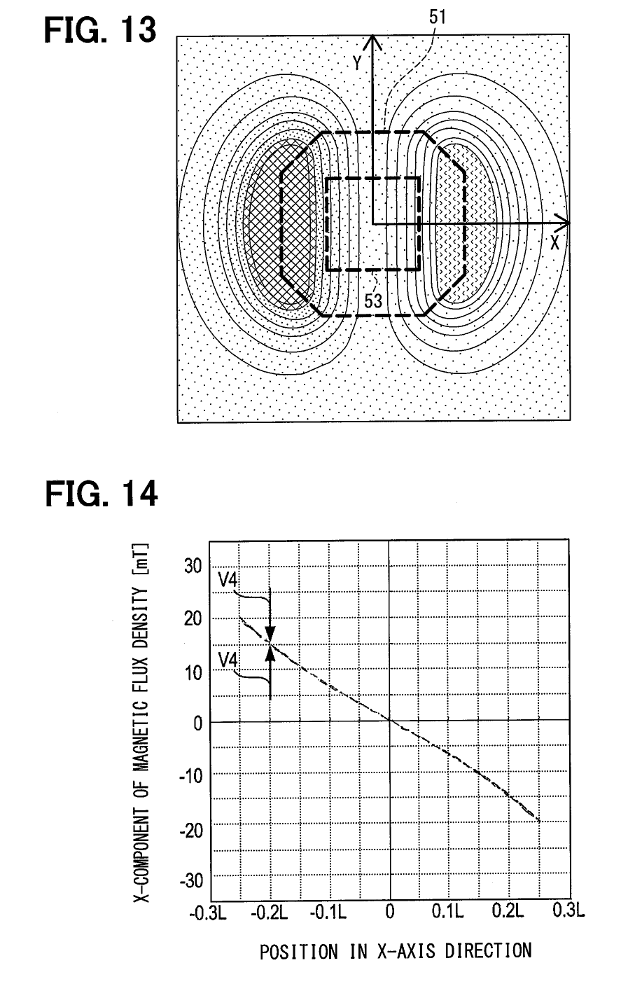

FIG. 13 shows the result of simulating the distribution of the X-axis-direction component in the density of the magnetic flux generated in the magnet 51 in the position detector 23 thus configured.

As shown in FIG. 13, the contour lines of the X-axis-direction component of the magnetic flux density are parallel with the Y-axis in the region corresponding to the center portion of the magnet 51. That is, when the position in the Y-axis direction is changed in the state where the position in the X-axis direction is fixed, changes in the X-axis-direction component of the magnetic flux density resulting from the position changes in the Y-axis direction are small. Accordingly, the X-axis-direction component of the magnetic flux density is generally constant.

FIG. 14 is a graph showing changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density shown in FIG. 13.

As shown in FIG. 14, the curve showing the changes in the X-axis-direction component of the magnetic flux density resulting from the position changes in the X-axis direction barely changes with the position changes from −0.25×L to +0.25×L in the Y-axis direction (see the arrow V4).

Note that the magnet 51 is formed to be line-symmetric with respect to a line along the Y-axis direction and also formed to be line-symmetric with respect to a line along the X-axis direction. Consequently, the contour lines of the Y-axis component of the magnetic flux density are parallel with the X-axis in the region corresponding to the center portion of the magnet 51. That is, when the position in the X-axis direction is changed in the state where the position in the Y-axis direction is fixed, changes in the Y-axis-direction component of the magnetic flux density resulting from the position changes in the X-axis direction are small. Accordingly, the Y-axis-direction component of the magnetic flux is generally constant. In addition, the curve showing the changes in the Y-axis-direction component of the magnetic flux density resulting from the position changes in the Y-axis direction barely changes with the position changes from −0.25×L to +0.25×L in the X-axis direction.

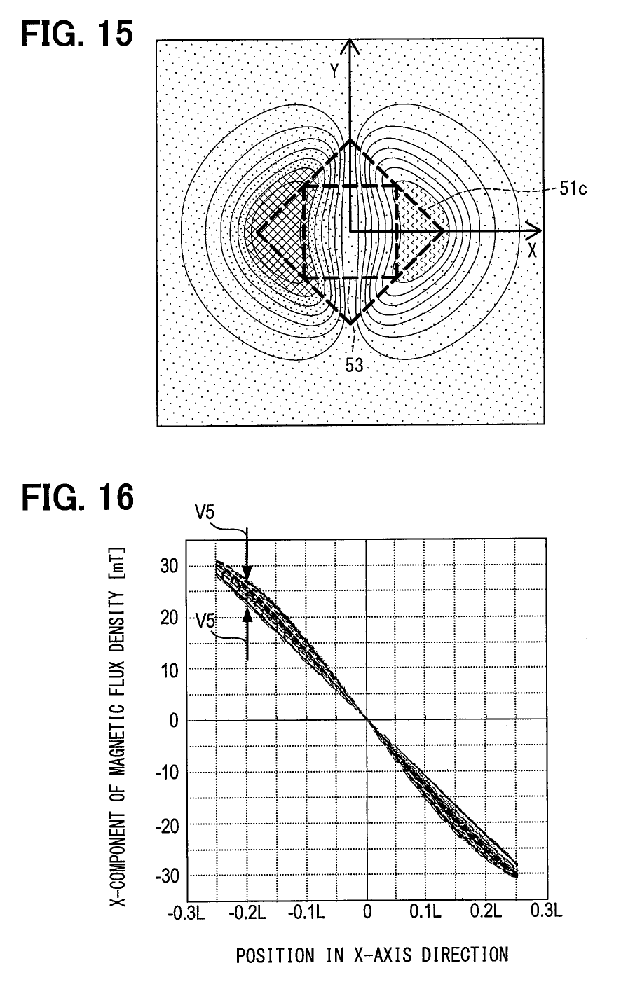

FIG. 15 shows the result of simulating the distribution of the X-axis-direction component of the magnetic flux density when a magnet 51C formed such that the blank distance C is 0.5×L is used instead of the magnet 51.

As shown in FIG. 15, the contour lines of the X-axis-direction component of the magnetic flux density are recessed in the region corresponding to the center portion of the magnet. That is, when the position in the Y-axis direction is changed in the state where the position in the X-axis direction is fixed, the X-axis-direction component of the magnetic flux density changes with the position changes in the Y-axis direction.

FIG. 16 is a graph showing changes in the X-axis-direction component of the magnetic flux density resulting from position changes in the X-axis direction when the position in the X-axis direction is changed in the state where the position in the Y-axis direction is fixed to −0.25×L, −0.245×L, . . . , 0, . . . , +0.245×L, and +0.25×L in the distribution of the magnetic flux density shown in FIG. 15.

As shown in FIG. 16, the curve showing the changes in the X-axis-direction component of the magnetic flux density resulting from the position changes in the X-axis direction shows large fluctuations with the position changes from −0.25×L to +0.25×L in the Y-axis direction (see the arrow V5).

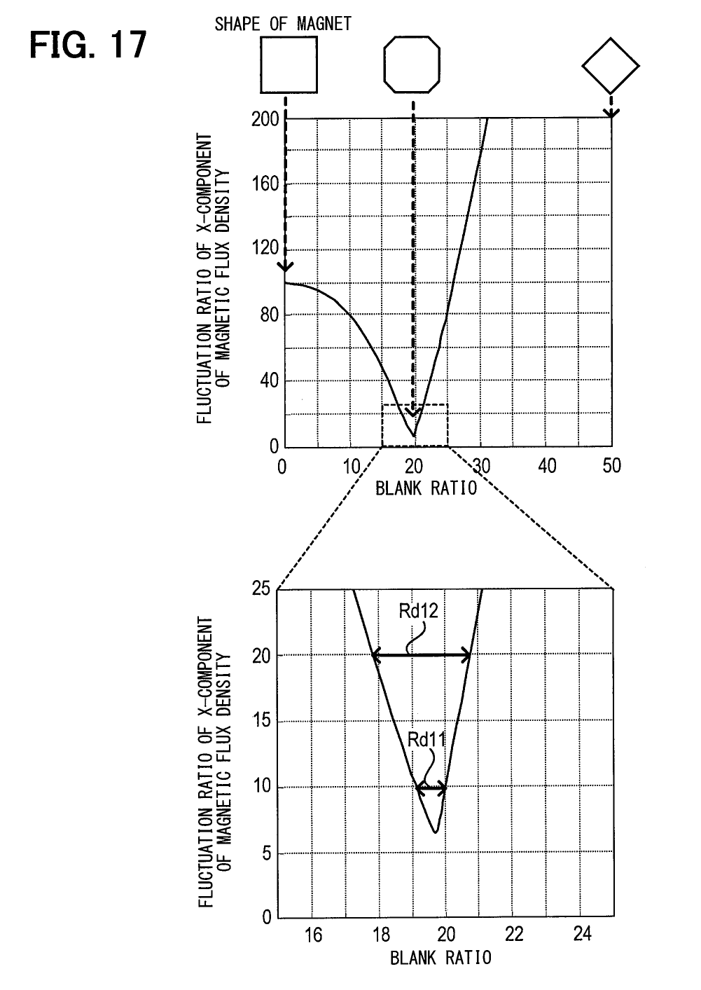

FIG. 17 is a graph showing the relationship between the shape of the magnet 51 and fluctuations in the X-axis-direction component of the magnetic flux density.

The abscissa axis of the graph shown in FIG. 17 represents the ratio (hereinafter referred to as the blank ratio) between the blank distance C and the distance (L in the present embodiment) between any two sides opposite to each other. For example, in the case of using a magnet formed in a square shape (see FIG. 6), there is no line connecting the respective end portions of the X-axis-direction sides 61 and 62 and the respective end portions of the Y-axis-direction sides 63 and 64 so that the blank distance C is 0 and the blank ratio C is 0. On the other hand, in the case of using a magnet formed such that the blank distance C is 0.5×L (see FIG. 15), the blank ratio is 50.

As shown in FIG. 17, as the blank ratio increases from 0, the fluctuation ratio decreases. When the blank ratio is about 20, the fluctuation ratio is minimum. As the blank ratio further increases from about 20, the fluctuation ratio increases.

By setting the blank ratio to 19 to 20, the fluctuation ratio can be reduced to a value of about not more than 10 (see the arrow Rd11). Also, by setting the blank ratio to 18 to 21, the fluctuation ratio can be reduced to a value of about not more than 20 (see the arrow Rd12).

The operation device 3 thus configured includes the movable part 21 which is movable in the X-axis direction and the Y-axis direction which are orthogonal to each other, the magnet 51 which is movable integrally with the movable part 21, and the magnetic sensor 53 which detects the magnetic field of the magnet 51.

The magnet 51 includes the magnetic field detection surface 70 having a shape including the two X-axis-direction sides 61 and 62, the two Y-axis-direction sides 63 and 64, and the four connection sides 65, 66, 67, and 68.

The two X-axis-direction sides 61 and 62 are arranged to be parallel with each other along the X-axis direction. The two Y-axis-direction sides 63 and 64 are arranged to be parallel with each other along the Y-axis direction. The four connection sides 65, 66, 67, and 68 each shaped as a line connect the respective end portions of the X-axis-direction sides 61 and 62 and the respective end portions of the Y-axis-direction sides 63 and 64.

The magnetic field detection surface 70 is formed to be line-symmetric with respect to a line parallel with the X-axis direction and line-symmetric with respect to a line parallel with the Y-axis.

The magnetic sensor 53 is disposed to oppose the magnetic field detection surface 70 and detect the X-axis-direction component of the magnetic flux density of the magnet 51 and the Y-axis-direction component of the magnetic flux density of the magnet 51.

The operation device 3 thus configured can detect the position of the movable part 21 using simple and easy arithmetic operations in the same manner as in the first embodiment.

While the description has been given heretofore of each of the embodiments of the present disclosure, the present disclosure is not limited to the foregoing embodiment. The present disclosure can be implemented in various embodiments as long as it belongs to the technical scope of the present disclosure.

For example, in the foregoing embodiment, the magnet 51 including the magnetic field detection surface 70 having a shape in which each of the corner portions of the square is shaped as an arc or a line is shown. However, the magnetic field detection surface 70 may also have a shape in which each of the corner portions of a rectangle is shaped as an arc or a line.

It may also be possible that the functions of one component in the foregoing embodiment are distributed to a plurality of components or the functions of a plurality of components are incorporated into one component. Alternatively, it may also be possible that a part of the configuration of the foregoing embodiment is omitted. Alternatively, it may also be possible that at least a part of the configuration of the foregoing embodiment is added to or substituted into the configuration of another of the foregoing embodiments. It is understood that the present disclosure has been described in accordance to the embodiments, but the present disclosure is not limited to the embodiments and the structure. The present disclosure also encompasses variations in the equivalent range as various modifications. In addition, embodiments and various combinations, and further, only one element thereof, less or more, and the form and other combinations including, are intended to fall within the spirit and scope of the present disclosure.

What is claimed is:

1. A position detection device comprising:
a movable part which is movable in an X-axis direction and a Y-axis direction which are orthogonal to each other;
a magnet which is movable integrally with the movable part; and
a magnetic field detector which detects a magnetic field of the magnet, wherein the magnet includes a magnetic field detection surface which is a surface having a shape including two X-axis-direction sides parallel with each other along the X-axis direction, two Y-axis-direction sides parallel with each other along the Y-axis direction, and four connection sides each shaped as an arc or a line to connect respective end portions of the X-axis-direction sides and respective end portions of the Y-axis-direction sides,
wherein the magnetic field detection surface is line-symmetric with respect to a line parallel with the X-axis direction and line-symmetric with respect to a line parallel with the Y-axis direction, and
wherein the magnetic field detector is disposed to oppose the magnetic field detection surface and detects a component of the magnetic field of the magnet in the X-axis direction and a component of the magnetic field of the magnet in the Y-axis direction.

2. The position detection device according to claim 1,
wherein each of the four connection sides is shaped as the arc, and
wherein a radius of the arc forming the connection side has a length which is 27 to 33% of a distance between the two X-axis-direction sides or a distance between the two Y-axis-direction sides.

3. The position detection device according to claim 1,
wherein each of the four connection sides is shaped as the line, and
wherein a distance between the end portion of each of the X-axis-direction sides and an extension line extending from the end portion of the adjacent Y-axis-direction side has a length which is 18 to 21% of a distance between the two X-axis-direction sides or a distance between the two Y-axis-direction sides.

4. The position detection device according to claim 1, further comprising:
an X-axis-position calculator which calculates a position of the magnet in the X-axis direction on the basis of the X-axis-direction component detected by the magnetic field detector without using the Y-axis-direction component detected by the magnetic field detector; and
a Y-axis-position calculator which detects a position of the magnet in the Y-axis direction on the basis of the Y-axis-direction component detected by the magnetic field detector without using the X-axis-direction component detected by the magnetic field detector.
